(19) United States
(12) Patent Application Publication
(10) Pub. No.: US 2017/0092274 A1
(43) Pub. Date: Mar. 30, 2017

(54) CAPTIONING SYSTEM AND/OR METHOD

(71) Applicant: Otojoy LLC, Santa Barbara, CA (US)

(72) Inventor: Thomas Kaufmann, Northrhine-Westphalia (DE)

(21) Appl. No.: 14/864,829

(22) Filed: Sep. 24, 2015

(51) Int. Cl. G10L 15/26; G06F 17/28

(52) U.S. Cl. CPC G10L 15/265; G06F 17/289

(57) ABSTRACT

Embodiments of systems and/or methods for a captioning system are disclosed.

### RELATED APPLICATION

This application is related to patent application Ser. No. 14/622,759 filed on Feb. 13, 2015, titled Telecoil Adapter, by Kaufmann, herein incorporated by reference in its entirety.

### BACKGROUND

1. Field

This disclosure relates to a captioning system and/or method.

2. Information

For many decades, captions have been provided for foreign language films to provide dialog translation for audience members not fluent in the language of the film. More recently, captions have also been provided to aid individuals with at least some hearing loss or with deafness, such as to follow film dialog. Captions may be provided on a screen visible to viewers in a theater or through a captioning system displayed to a single user privately on a device, using methods such as rear window captioning, caption glasses, or display devices, which may placed in a cup holder, for example.

Captioning has been widely adopted in movie theaters around the world, including the United States. Recently, the United States Department of Justice (DOJ) published a notice proposing to amend the Americans with Disabilities Act (ADA) Title III regulation to provide movie captioning for persons with hearing disabilities. See http://www.ada.gov/regs2014/movie_nprm_index.htm. The DOJ is proposing to provide a consistent nationwide standard for movie theaters to exhibit movies with captioning. Title III of the ADA includes provisions so that movie theaters and/or other public accommodations provide effective communication through use of auxiliary aids and/or services.

While captioning is widespread in movie theaters, it is not typically found in live performances or live performance venues, such as theater, lectures, presentations, meetings, etc. For such events, typically, content is not presented to a viewer in an audience from a pre-recorded medium. Therefore, it may be challenging for captions to be generated and presented to such a viewer, such as with appropriate synchronization. Some performing arts theaters hire professional caption providers, such as court reporters, captioners, or CART (Computer Assisted Real-time Translation) providers, to provide captioning services. In these environments, captions are typically displayed on a screen using a projector and audience viewers who want to use the service sit in specific seats to see a projection screen. Thus, captions are at times visible to more than one audience viewer rather than presented discretely to individual audience members. A caption provider typically may pre-enter the script of a performance into a computer in advance and scroll caption text up in time with a performance. Another approach may involve listening and typing what is heard. Captions for live performances, therefore, are generally not widely available to members of an audience.

Recent advances, however, have enhanced robustness, accuracy, and/or efficiency of speech recognition systems. Widespread availability of internet access and/or network connectivity, such as, in buildings and/or on computing devices, such as smartphones, have also made speech recognition systems more available to the general public via cloud-based and/or cloud-type services. Thus, in some cases, speech recognition, such as via cloud-based and/or cloud-type services, may be utilized for voice prompts and/or dictation on a variety of mobile computing devices, such as smartphones, tablets, and/or laptop computers, for example.

### BRIEF DESCRIPTION OF DRAWINGS

Claimed subject matter is particularly pointed out and distinctly claimed in the concluding portion of the specification. However, both to an organization and/or method of operation, together with objects, features, and/or advantages thereof, it may be best understood by reference to the following detailed description if read with the accompanying drawings in which:

FIG. 1 is a schematic diagram illustrating an embodiment;

FIGS. 2 and 3 are flow diagrams illustrating an embodiment of a method of using the embodiments of FIG. 1; and

FIG. 4 is a schematic diagram illustrating an embodiment of a computing device.

Reference is made in the following detailed description to accompanying drawings, which form a part hereof, wherein the numerals may designate like parts throughout to indicate corresponding and/or analogous components. It will be appreciated that components illustrated in the figures have not necessarily been drawn to scale, such as for simplicity or clarity of illustration. For example, dimensions of some components may be exaggerated relative to other components. Further, it is understood that other embodiments may be utilized. Furthermore, structural and/or other changes may be made without departing from claimed subject matter. It should also be noted that directions and/or references, for example, up, down, top, bottom, and so on, may be utilized to facilitate discussion of drawings and/or are not intended to restrict application of claimed subject matter. Therefore, the following description is not to be taken to limit claimed subject matter and/or equivalents.

### DETAILED DESCRIPTION

References throughout this specification to one implementation, an implementation, one embodiment, an embodiment and/or the like means that a particular feature, structure, and/or characteristic described in connection with a particular implementation and/or embodiment is included in at least one implementation and/or embodiment of claimed subject matter. Thus, appearances of such phrases, for example, in various places throughout this specification are not necessarily intended to refer to the same implementation or to any one particular implementation described. Furthermore, it is to be understood that particular features, structures, and/or characteristics described are capable of being combined in various ways in one or more implementations and, therefore, are within intended claim scope, for example. In general, of course, these and other issues vary with context. Therefore, particular context of description and/or usage provides helpful guidance regarding inferences to be drawn.

With advances in technology, it has become more typical to employ distributed computing approaches in which portions of a problem, such as signal processing of signal samples, for example, may be allocated among computing devices, including one or more clients and/or one or more servers, via a computing and/or communications network, for example. A network may comprise two or more network devices and/or may couple network devices so that signal communications, such as in the form of signal packets and/or frames (e.g., comprising one or more signal samples), for example, may be exchanged, such as between a server and a client device and/or other types of devices, including between wireless devices coupled via a wireless network, for example.

An example of a distributed computing system comprises the Hadoop distributed computing system, which employs a map-reduce type of architecture. In this context, the terms map-reduce architecture and/or similar terms are intended to refer a distributed computing system implementation for processing and/or for generating large sets of signal samples employing a parallel, distributed process performed over a network of individual computing devices. A map operation and/or similar terms refer to processing of signals to generate one or more key-value pairs and to distribute the one or more pairs to the computing devices of the network. A reduce operation and/or similar terms refer to processing of signals via a summary operation (e.g., such as counting the number of students in a queue, yielding name frequencies). A system may employ such an architecture for processing by marshalling distributed servers, running various tasks in parallel, and managing communications and signal transfers between various parts of the system, in an embodiment. (See, for example Jeffrey Dean et al. “Large Scale Distributed Neural Networks,” Advances in Neural Information Processing Systems 25, 2012, pp 1232-1240.) As mentioned, one non-limiting, but well-known example comprises the Hadoop distributed computing system. It refers to an open source implementation of a map-reduce type architecture, but may include other aspects, such as the Hadoop distributed file system (HDFS). In general, therefore, Hadoop and/or similar terms refer to an implementation scheduler for executing large processing jobs using a map-reduce architecture.

In this context, the term network device refers to any device capable of communicating via and/or as part of a network and may comprise a computing device. While network devices may be capable of sending and/or receiving signals (e.g., signal packets and/or frames), such as via a wired and/or wireless network, they may also be capable of performing arithmetic and/or logic operations, processing and/or storing signals (e.g., signal samples), such as in memory as physical memory states, and/or may, for example, operate as a server in various embodiments. Network devices capable of operating as a server, or otherwise, may include, as examples, dedicated rack-mounted servers, desktop computers, laptop computers, set top boxes, tablets, netbooks, smart phones, wearable devices, integrated devices combining two or more features of the foregoing devices, the like or any combination thereof. As mentioned, signal packets and/or frames, for example, may be exchanged, such as between a server and a client device and/or other types of network devices, including between wireless devices coupled via a wireless network, for example. It is noted that the terms, server, server device, server computing device, server computing platform and/or similar terms are used interchangeably. Similarly, the terms client, client device, client computing device, client computing platform and/or similar terms are also used interchangeably. While in some instances, for ease of description, these terms may be used in the singular, such as by referring to a “client device” or a “server device,” the description is intended to encompass one or more client devices and/or one or more server devices, as appropriate. Along similar lines, references to a “database” are understood to mean, one or more databases and/or portions thereof, as appropriate.

It should be understood that for ease of description, a network device (also referred to as a networking device) may be embodied and/or described in terms of a computing device. However, it should further be understood that this description should in no way be construed that claimed subject matter is limited to one embodiment, such as a computing device and/or a network device, and, instead, may be embodied as a variety of devices or combinations thereof, including, for example, one or more illustrative examples.

Likewise, in this context, the terms “coupled”, “connected,” and/or similar terms are used generically. It should be understood that these terms are not intended as synonyms. Rather, “connected” is used generically to indicate that two or more components, for example, are in direct physical, including electrical, contact; while, “coupled” is used generically to mean that two or more components are potentially in direct physical, including electrical, contact; however, “coupled” is also used generically to also mean that two or more components are not necessarily in direct contact, but nonetheless are able to co-operate and/or interact. The term coupled is also understood generically to mean indirectly connected, for example, in an appropriate context.

The terms, “and”, “or”, “and/or” and/or similar terms, as used herein, include a variety of meanings that also are expected to depend at least in part upon the particular context in which such terms are used. Typically, “or” if used to associate a list, such as A, B or C, is intended to mean A, B, and C, here used in the inclusive sense, as well as A, B or C, here used in the exclusive sense. In addition, the term “one or more” and/or similar terms is used to describe any feature, structure, and/or characteristic in the singular and/or is also used to describe a plurality and/or some other combination of features, structures and/or characteristics. Likewise, the term “based on” and/or similar terms are understood as not necessarily intending to convey an exclusive set of factors, but to allow for existence of additional factors not necessarily expressly described. Of course, for all of the foregoing, particular context of description and/or usage provides helpful guidance regarding inferences to be drawn. It should be noted that the following description merely provides one or more illustrative examples and claimed subject matter is not limited to these one or more illustrative examples; however, again, particular context of description and/or usage provides helpful guidance regarding inferences to be drawn.

A network may also include now known, and/or to be later developed arrangements, derivatives, and/or improvements, including, for example, past, present and/or future mass storage, such as network attached storage (NAS), a storage area network (SAN), and/or other forms of computing and/or device readable media, for example. A network may include a portion of the Internet, one or more local area networks (LANs), one or more wide area networks (WANs), wire-line type connections, wireless type connections, other connections, or any combination thereof. Thus, a network may be worldwide in scope and/or extent. Likewise, sub-networks, such as may employ differing architectures and/or may be substantially compliant and/or substantially compatible with differing protocols, such as computing and/or communication protocols (e.g., network protocols), may interoperate within a larger network. In this context, the term sub-network and/or similar terms, if used, for example, with respect to a network, refers to the network and/or a part thereof. Sub-networks may also comprise links, such as physical links, connecting and/or coupling nodes, such as to be capable to transmit signal packets and/or frames between devices of particular nodes, including wired links, wireless links, or combinations thereof. Various types of devices, such as network devices and/or computing devices, may be made available so that device interoperability is enabled and/or, in at least some instances, may be transparent to the devices. In this context, the term transparent refers to devices, such as network devices and/or computing devices, communicating via a network in which the devices are able to communicate via intermediate devices of a node, but without the communicating devices necessarily specifying one or more intermediate devices of one or more nodes and/or may include communicating as if intermediate devices of intermediate nodes are not necessarily involved in communication transmissions. For example, a router may provide a link and/or connection between otherwise separate and/or independent LANs. In this context, a private network refers to a particular, limited set of network devices able to communicate with other network devices in the particular, limited set, such as via signal packet and/or frame transmissions, for example, without a need for re-routing and/or redirecting transmissions. A private network may comprise a stand-alone network; however, a private network may also comprise a subset of a larger network, such as, for example, without limitation, all or a portion of the Internet. Thus, for example, a private network “in the cloud” may refer to a private network that comprises a subset of the Internet, for example. Although signal packet and/or frame transmissions may employ intermediate devices of intermediate nodes to exchange signal packet and/or frame transmissions, those intermediate devices may not necessarily be included in the private network by not being a source or destination for one or more signal packet and/or frame transmissions, for example. It is understood in this context that a private network may provide outgoing network communications to devices not in the private network, but devices outside the private network may not necessarily be able to direct inbound network communications to devices included in the private network.

The Internet refers to a decentralized global network of interoperable networks that comply with the Internet Protocol (IP). It is noted that there are several versions of the Internet Protocol. Here, the term Internet Protocol, IP, and/or similar terms, is intended to refer to any version, now known and/or later developed of the Internet Protocol. The Internet includes local area networks (LANs), wide area networks (WANs), wireless networks, and/or long haul public networks that, for example, may allow signal packets and/or frames to be communicated between LANs. The term World Wide Web (WWW or Web) and/or similar terms may also be used, although it refers to a part of the Internet that complies with the Hypertext Transfer Protocol (HTTP). For example, network devices may engage in an HTTP session through an exchange of appropriately substantially compatible and/or substantially compliant signal packets and/or frames. It is noted that there are several versions of the Hypertext Transfer Protocol. Here, the term Hypertext Transfer Protocol, HTTP, and/or similar terms is intended to refer to any version, now known and/or later developed. It is likewise noted that in various places in this document substitution of the term Internet with the term World Wide Web (‘Web’) may be made without a significant departure in meaning and may, therefore, not be inappropriate in that the statement would remain correct with such a substitution.

Although claimed subject matter is not in particular limited in scope to the Internet and/or to the Web; nonetheless, the Internet and/or the Web may without limitation provide a useful example of an embodiment at least for purposes of illustration. As indicated, the Internet and/or the Web may comprise a worldwide system of interoperable networks, including interoperable devices within those networks. The Internet and/or Web has evolved to a public, self-sustaining facility that may be accessible to tens of millions of people or more worldwide. Also, in an embodiment, and as mentioned above, the terms “WWW” and/or “Web” refer to a part of the Internet that complies with the Hypertext Transfer Protocol. The Internet and/or the Web, therefore, in this context, may comprise an service that organizes stored content, such as, for example, text, images, video, etc., through the use of hypermedia, for example. A HyperText Markup Language (“HTML”), for example, may be utilized to specify content and/or to specify a format for hypermedia type content, such as in the form of a file and/or an “electronic document,” such as a Web page, for example. An Extensible Markup Language (“XML”) may also be utilized to specify content and/or format of hypermedia type content, such as in the form of a file or an “electronic document,” such as a Web page, in an embodiment. Of course, HTML and/or XML are merely example languages provided as illustrations. Furthermore, HTML and/or XML (and/or similar terms) is intended to refer to any version, now known and/or later developed of these languages. Likewise, claimed subject matter is not intended to be limited to examples provided as illustrations, of course.

As used herein, the term “Web site” and/or similar terms refer to a collection of related Web pages. Also as used herein, “Web page” and/or similar terms refer to any electronic file and/or electronic document, such as may be accessible via a network, including by specifying a URL for accessibility via the Web, in an example embodiment. As alluded to above, in one or more embodiments, a Web page may comprise content coded using one or more languages, such as, for example, markup languages, including HTML and/or XML, although claimed subject matter is not limited in scope in this respect. Also, in one or more embodiments, application developers may write code in the form of JavaScript, for example, to provide content to populate one or more templates, such as for an application. The term ‘JavaScript’ and/or similar terms are intended to refer to any now known and/or later developed version of this programming language. However, JavaScript is merely an example programming language. As was mentioned, claimed subject matter is not intended to be limited to examples and/or illustrations.

As used herein, the terms “entry”, “electronic entry”, “document”, “electronic document”, “content”, “digital content”, “item”, and/or similar terms are meant to refer to signals and/or states in a physical format, such as a digital signal and/or digital state format, e.g., that may be perceived by a user if displayed, played and/or otherwise executed by a device, such as a digital device, including, for example, a computing device, but otherwise might not necessarily be perceivable by humans (e.g., in a digital format). Likewise, in this context, content (e.g., digital content) provided to a user in a form so that the user is able to perceive the underlying content itself (e.g., hear audio or see images, as examples) is referred to, with respect to the user, as ‘consuming’ content, ‘consumption’ of content, ‘consumable’ content and/or similar terms. For one or more embodiments, an electronic document may comprise a Web page coded in a markup language, such as, for example, HTML (hypertext markup language). In another embodiment, an electronic document may comprise a portion or a region of a Web page. However, claimed subject matter is not intended to be limited in these respects. Also, for one or more embodiments, an electronic document and/or electronic entry may comprise a number of components. Components in one or more embodiments may comprise text, for example, in the form of physical signals and/or physical states (e.g., capable of being physically displayed). Also, for one or more embodiments, components may comprise a graphical object, such as, for example, an image, such as a digital image, and/or sub-objects, such as attributes thereof, which, again, comprise physical signals and/or physical states (e.g., capable of being physically displayed). In an embodiment, content may comprise, for example, text, images, audio, video, and/or other types of electronic documents and/or portions thereof, for example.

Also as used herein, one or more parameters may be descriptive of a collection of signal samples, such as one or more electronic documents, and exist in the form of physical signals and/or physical states, such as memory states. For example, one or more parameters, such as referring to an electronic document comprising an image, may include parameters, such as time of day at which an image was captured, latitude and longitude of an image capture device, such as a camera, for example, etc. In another example, one or more parameters relevant to content, such as content comprising a technical article, may include one or more authors, for example. Claimed subject matter is intended to embrace meaningful, descriptive parameters in any format, so long as the one or more parameters comprise physical signals and/or states, which may include, as parameter examples, name of the collection of signals and/or states (e.g., file identifier name), technique of creation of an electronic document, purpose of an electronic document, time and date of creation of an electronic document, logical path of an electronic document (or portion thereof), encoding formats and/or standards used for encoding an electronic document, and so forth.

Signal packets and/or frames, also referred to as signal packet transmissions and/or signal frame transmissions, may be communicated between nodes of a network, where a node may comprise one or more network devices and/or one or more computing devices, for example. As an illustrative example, but without limitation, a node may comprise one or more sites employing a local network address. Likewise, a device, such as a network device and/or a computing device, may be associated with that node. A signal packet and/or frame may, for example, be communicated via a communication channel and/or a communication path, such as comprising a portion of the Internet and/or the Web, from a site via an access node coupled to the Internet. Likewise, a signal packet and/or frame may be forwarded via network nodes to a target site coupled to a local network, for example. A signal packet and/or frame communicated via the Internet and/or the Web, for example, may be routed via a path comprising one or more gateways, servers, etc. that may, for example, route a signal packet and/or frame substantially in accordance with a target and/or destination address and availability of a network path of network nodes to the target and/or destination address. Although the Internet and/or the Web comprise a network of interoperable networks, not all of those interoperable networks are necessarily available and/or accessible to the public.

In particular implementations, a network protocol for communicating between devices may be characterized, at least in part, substantially in accordance with a layered description, such as the so-called Open Systems Interconnection (OSI) seven layer approach and/or description. A network protocol refers to a set of signaling conventions, such as for computing and/or communications transmissions, for example, as may take place between and/or among devices in a network, typically network devices; for example, devices that substantially comply with the protocol and/or that are substantially compatible with the protocol. In this context, the term “between” and/or similar terms are understood to include “among” if appropriate for the particular usage and vice-versa. Likewise, in this context, the terms “compatible with”, “comply with” and/or similar terms are understood to include substantial compliance and/or substantial compatibility.

Typically, a network protocol, such as protocols characterized substantially in accordance with the aforementioned OSI description, has several layers. These layers may be referred to here as a network stack. Various types of transmissions, such as network transmissions, may occur across various layers. A lowest level layer in a network stack, such as the so-called physical layer, may characterize how symbols (e.g., bits and/or bytes) are transmitted as one or more signals (and/or signal samples) over a physical medium (e.g., twisted pair copper wire, coaxial cable, fiber optic cable, wireless air interface, combinations thereof, etc.). Progressing to higher-level layers in a network protocol stack, additional operations may be available by initiating network transmissions that are substantially compatible and/or substantially compliant with a particular network protocol at these higher-level layers. For example, higher-level layers of a network protocol may, for example, affect device permissions, user permissions, etc.

A virtual private network (VPN) may enable a remote device to more securely (e.g., more privately) communicate via a local network. A router may allow network communications in the form of network transmissions (e.g., signal packets and/or frames), for example, to occur from a remote device to a VPN server on a local network. A remote device may be authenticated and a VPN server, for example, may create a special route between a local network and the remote device through an intervening router. However, a route may be generated and/or also regenerated if the remote device is power cycled, for example. Also, a VPN typically affects a single remote device.

Language, such as signal, signals, signal samples, and/or similar terms, may be used interchangeably throughout. It is noted that no meaningful distinction is intended to be made between these terms, whether used singularly or in plural form. It is likewise understood that a signal, signals and/or signal samples, such as electromagnetic signals, may go through an innumerable number of signal transformations before being received at an emitter to produce stimuli, such as auditory or visual stimuli. Examples of auditory emitters may comprise speakers, headphones, ear buds, etc. Examples of devices that provide visual stimuli may comprise displays, monitors, CRTs, screens, display surfaces, etc. If referring to as auditory, visual, and/or textual content (e.g., signals), while such content may be provided in a particular physical form, such as in the form of electromagnetic signals, as one example, it is understood that content is intended to be referring to a physical phenomenon or physical phenomena that the signals represent. Thus, for example, auditory signals (e.g., audio signals) may refer to electromagnetic signals transmitted, such as via a wire or wirelessly, to an emitter, such as a speaker, so that underlying audio content in such audio signals, transmitted in the form of electromagnetic signals, is capable of being heard. In this example, the emitter may produce auditory output signals in response to received electromagnetic signals. In addition, for example, visual signals and/or textual signals (e.g., signals representing text) may be transmitted in the form of electromagnetic signals, such as via a wire or wirelessly, to a device that provides visual stimuli, such as a monitor or display, so that underlying content (e.g., visual content and/or textual content) may be comprehended (e.g., seen and/or heard). For example, underlying signal content may comprise still image content, video content, textual content, etc. Likewise, electromagnetic signals may be transformed from analog to digital or vice-versa. Furthermore, signals may be compressed, encoded, packetized, encrypted, etc. and still remain auditory, visual, and/or textual content in this context. The term waveform refers to a particular type of signal or signals, e.g., having a particular form and shape including, for example, signals having a form of a wave.

For many decades, captions have been provided for foreign language films to provide dialog translation for audience members not fluent in the language of the film. More recently, captions have also been provided to aid individuals with at least some hearing loss or with deafness, such as to follow film dialog. Captions may be provided on a screen visible to viewers in a theater or through a captioning system displayed to a single user privately on a device, using methods such as rear window captioning, caption glasses, or display devices, which may be placed in a cup holder, for example.

Captioning has been widely adopted in movie theaters around the world, including the United States. Recently, the United States Department of Justice (DOJ) published a notice proposing to amend the Americans with Disabilities Act (ADA) Title III regulation to provide movie captioning for persons with hearing disabilities. See http://www.ada.gov/regs2014/movie_nprm_index.htm. The DOJ is proposing to provide a consistent nationwide standard for movie theaters to exhibit movies with captioning. Title III of the ADA includes provisions so that movie theaters and/or other public accommodations provide effective communication through use of auxiliary aids and/or services.

While captioning is widespread in movie theaters, it is not typically found in live performances or live performance venues, such as theater, lectures, presentations, meetings, etc. For such events, typically, content is not presented to a viewer in an audience from a pre-recorded medium. Therefore, it may be challenging for captions to be generated and presented to such a viewer, such as with appropriate synchronization. Some performing arts theaters hire professional caption providers, such as court reporters, captioners, or CART (Computer Assisted Real-time Translation) providers, to provide captioning services. In these environments, captions are typically displayed on a screen using a projector and audience viewers who want to use the service sit in specific seats to see a projection screen. Thus, captions are at times visible to more than one audience viewer rather than presented discretely to individual audience members. A caption provider typically may pre-enter the script of a performance into a computer in advance and scroll caption text up in time with a performance. Another approach may involve listening and typing what is heard. Captions for live performances, therefore, are generally not widely available to members of an audience.

Recent advances, however, have enhanced robustness, accuracy, and/or efficiency of speech recognition systems. Widespread availability of internet access and/or network connectivity, such as, in buildings and/or on computing devices, such as smartphones, have also made speech recognition systems more available to the general public via cloud-based and/or cloud-type services. Thus, in some cases, speech recognition, such as via cloud-based and/or cloud-type services. may be utilized for voice prompts and/or dictation on a variety of mobile computing devices, such as smartphones, tablets, and/or laptop computers, for example.

Throughout this document, language, such as users, individuals, audience members, and/or similar terms, may be referred to interchangeably. Users may be affected with conditions that impair an ability to hear and, thus, may use an assistive device for amplification and/or to perform other signal conditioning to improve sound perception. Likewise, users may read generated captions to understand spoken presentations made to an audience, for example. Captioning systems are one of a variety of techniques of assistive technology, and may assist individuals with, for example, hearing loss, difficulty with speech intelligibility, and/or clarity of sound, such as in the presence of external noises (e.g., ambient noise, echo, and/or reverberation) that typically will accompany a live performance to an audience.

Further, captioning systems may also assist individuals in situations where a sound and/or audio source, such as a loudspeaker and/or a person speaking, may be distant, especially for individuals with hearing aids and/or cochlear implants. For example, a microphone may be placed so as to pick up additional surrounding sounds beyond sounds desired and/or intended to be picked up, such as music, other speech and/or background noise, for example, making it more challenging for a user to understand and/or comprehend speech content of particular interest, for example. Currently, captioning systems are utilized with pre-recorded content, for example, such as in movie theaters, with television programs, and/or other pre-recorded video content. However, captioning systems are usually not utilized for a live performance, such as presentations, lectures, speeches, live theater, sermons, board meetings, or classes, for a variety of reasons.

Most venues for a live performance, such as theaters, auditoriums, lecture halls, classrooms, places of worship, board rooms, meeting rooms, and/or ballrooms, for example, feature public address systems with microphones and loudspeakers typically to enhance sound quality of generated audio for an audience, such as provided by a live speaker, for example. Thus, an assistive listening system, such as a frequency modulation (FM) system, an infrared system, and/or a hearing loop system may transfer sound wirelessly in a variety of manners from a public address system to an audience member receiving device, such as a headset receiver, a hearing aid, or a cochlear implant, for example. Despite such assistive listening systems, individuals may struggle with listening comprehension and/or may benefit from additional listening assistance. Also, assistive listening systems are not always available. Furthermore, individuals who are deaf (or virtually so) typically are not helped by these example systems. A captioning system, such as for a live performance, therefore, for example, may provide additional assistance for audience members with hearing impairment and/or hearing loss.

As mentioned, computing devices (e.g., mobile computing devices, tablets, and/or laptops) have a capability to connect, often wirelessly, to a network, e.g., the Internet, and utilize speech recognition (e.g., for voice commands and/or dictation of text). However, in embodiments, if a microphone for a device is distant from a source for audio and/or a signal-to-noise ratio is relatively low, speech recognition techniques may exhibit relatively low accuracy, if any results at all are obtained. Accordingly, utilizing a microphone of a device, in combination with speech recognition, to generate and/or display captions for a live performance intended for an audience may not necessarily be practical, and/or may produce poor results.

In this context, “speech” refers to audible sounds and/or expressions that have a commonly understood meaning to an individual (e.g., human being). “Speech”, therefore, may comprise words, phrases, or other commonly understood utterances usually, but not necessarily, articulated by an individual (e.g., human being). In this context, “speech recognition” refers to a capability of identifying speech content (e.g., speech) and converting the speech content into a signal capable of being provided to a user as consumable content (e.g., audible content, visual content, textual content, etc.). In an embodiment, speech recognition may be performed utilizing instructions executable by a processor. Likewise, in an embodiment, instructions may be stored in memory of a computing device, as described below, for example. In this context, “captioning” refer to a process of generating text content that corresponds to speech content (e.g., speech) intended for an audience. In this context, captions usually visually communicate that which is being audibly spoken. In this context, in particular, “caption text” refers to speech recognition-generated captions, such as if speech recognition is performed by a computing device.

In this context, the term “audio signals” refers to audio content (e.g., in the form of signals, which may include sound signals and/or may include signals being communicated (e.g., transmitted and/or received) in another form, such as electromagnetic signals, for example). Furthermore, an audio signal that predominantly includes speech content (e.g., speech) is referred to as an audio speech signal. Likewise, “text signals” (or “textual signals”) refers to signals that predominantly include text or textual content and “video signals” refers to signals that predominantly include video content. However, it is not unusual for video signals to also include audio signals, which are referred to as audio-visual signals in this context.

In this context, the term “audio source” refers to initial generation or creation of consumable audio content for providing (e.g., presenting and/or performing) to an audience. It does not exclude pre-recorded audio content where the initial generation of the consumable audio content is for a corresponding audio presentation, for example. In contrast, the term “live audio source” refers to initial generation or creation of consumable audio content for an audience, in the form of “live audio signals,” presented without measurable delay and that has not been pre-recorded. Thus, for example, an individual delivering a speech to an audience may comprise a live audio (e.g, speech) source and the speech may be delivered in the form of live audio (e.g., speech) signals. In this context, performance level audio content (also referred to as performance audio content) refers to audio content intended for an audience captured in relatively close proximity to a live audio source and/or captured in an environment and/or in a manner so as to have a relatively higher signal to noise ratio than is typical for a live performance environment that includes an audience. For example, approximately a 20 dB improvement or more may be expected as a result of a variety of techniques, including signal processing, close proximity between a device to capture an audio signal and audio signal generation, etc., to reduce and/or remove ambient noise typical for a live performance environment that includes an audience. Furthermore, performance level audio signals may be provided by a performance level audio source (e.g., an audio source provided performance level audio content). Thus, in some cases, performance level audio content may be captured from a performance level audio source that may not necessarily comprise a live audio source.

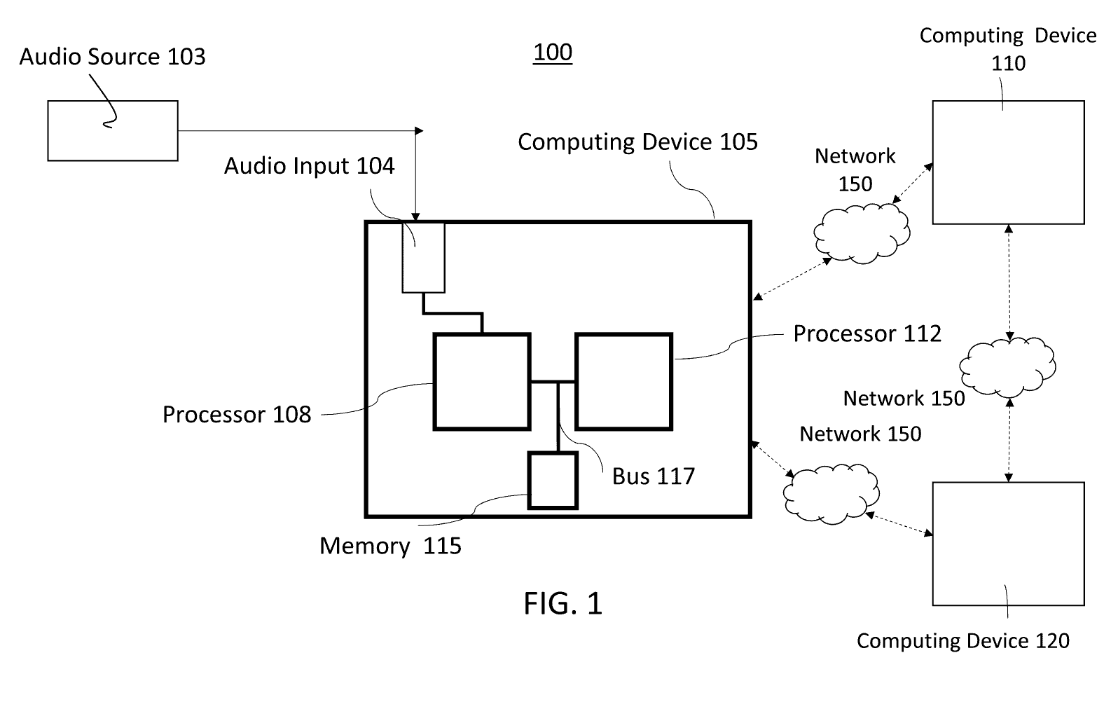

In an embodiment, a system embodiment 100 may comprise a computing device 105, a computing device 110, and/or a computing device 120, although this is merely one non-limiting illustration. However, in an embodiment, such as shown in FIG. 1, for example, a computing device, such as 105, may comprise one or more processors, such as 108 and 112, and a memory, such as 115, that may communicate by way of a communication bus, such as 117, for example, as shown. Examples, however, as suggested, are provided merely as illustrations. It is not intended that claimed subject matter be limited in scope to illustrative examples. Although an illustrative embodiment is presented, a variety of embodiments are possible.

Nonetheless, referring to FIG. 1, a live audio source 103, for example, may provide a live audio signal that includes audio content. For example, a live performance to an audience of individuals may take place, such as live theater, as simply a non-limiting example. A live performance to an audience may likewise comprise a presentation, a lecture, a speech, a sermon, a board meeting, and/or a class at school, to provide a few additional non-limiting examples.

Likewise, the live audio signal may be captured by any one of a host of known techniques. For example any of a variety of microphones, such as handheld, lapel, headset microphones, boundary microphones, shotgun microphones, condenser microphones, dynamic microphones, unidirectional, bi-directional and/or omnidirectional microphones, may be connected to a device for audio signal processing, which may, comprise a sound board and/or audio mixer with a pre-amplifier, as an example. Likewise, in an embodiment, similar devices and/or additional operations may be included, such as for signal compression, signal enhancement, special sound effects, etc.

Thus, in an embodiment, an audio source, such as at a live performance venue, may generate an audio signal including speech or having audible speech content. Likewise, as previously suggested, a performance level audio signal may be produced as a result of capturing an audio signal in a manner so as to limit the presence of ambient noise, for example. For example, a performance level audio signal may be generated, such as via processing through a sound board (not shown), for example, from a live audio signal. In this context, the term sound board refers to circuitry to produce or handle audio signals, which may include signal processing, such as use of signal filtering, including digital signal filtering, discussed more below, and/or analog signal filtering. Likewise, a performance level audio signal may be generated, through a combination of approaches and may be communicated to computing device 105, such as via input port 104, for example. Thus, an audio mixer, a microphone, an audio receiver, and/or combinations thereof, may provide a signal to input signal port 104, although other embodiments are possible. In an embodiment, input signal port 104 may, therefore, comprise, for example, an analog audio input port, such as, to provide a few examples, an XLR input port, an RCA input port, a 3.5 mm jack, a ¼ inch jack, or a Phoenix terminal connector, although other embodiments are possible.

In an embodiment, a computing device 105 may employ an analog-to-digital converter (ADC), for example, for a communicated analog audio signal. In an embodiment, an audio input port 104 may comprise, likewise, a digital audio input port, such as an optical or a Toslink input port, a coaxial input port, a RJ-45 jack, and/or an Ethernet connector, although other embodiments are possible. Thus, an analog or a digital audio signal may be communicated. If a digital signal is communicated, ADC may be omitted, of course.

In some embodiments, computing device 105 may, as an example, “pull” signals from another device, such as a server, whereas in some embodiments, another device, such as a server, again, as an example, may “push” signals to computing device 105. This may take place a variety of ways, which may be periodic, scheduled, or asynchronous, as examples. Communications involving binary digital signals, such as via a computing and/or communications network, for example, has been described in some detail previously, and need not be repeated here, other than in passing reference. Of course, claimed subject matter is not limited in scope to such approaches. Rather, these are provided as illustrative examples.

As alluded to above, one approach to generating a performance level audio signal may include employing signal processing, as is well-known, to improve signal-to-noise for the resulting performance audio signal, such as digital signal processing. See, for example, A. Antoniou, Digital Filters: Analysis, Design, and Applications, New York, N.Y.: McGraw-Hill, 1993; J. O. Smith III, Introduction to Digital Filters with Audio Applications, Center for Computer Research in Music and Acoustics (CCRMA), Stanford University, September 2007 Edition; S. K. Mitra, Digital Signal Processing: A Computer-Based Approach, New York, N.Y.: McGraw-Hill, 1998; A. V. Oppenheim and R. W. Schafer, Discrete-Time Signal Processing, Upper Saddle River, N.J.: Prentice-Hall, 1999. Thus, in an embodiment, a performance level audio speech signal may be generated at least in part by computing device 105. In an embodiment, instructions, stored in memory 115 of computing device 105, and executable by processor 108, may be employed to implement any one of a variety of well-known and well-studied digital signals filters to at least in part generate a performance level audio signal. As mentioned, a combination of techniques may likewise be employed to generate a performance level audio signal, also referred to as a performance audio speech signal if the signal predominantly includes speech content, as previously mentioned.

In an embodiment illustrated in FIG. 1, computing device 105 may further include a capability to process audio content, such as performance level audio signals, to generate caption text content, such as caption text signals. In an embodiment, instructions capable of implementing speech recognition may be stored in memory 115 of computing device 105 and be executable to convert performance audio speech signals having performance audio speech content to caption text content (e.g., caption text signals). In an embodiment, instructions utilized by computing device 105 to implement speech recognition may comprise, as examples, Nuance Dragon Dictation (see, for example, http://dragonmobile.nuancemobiledeveloper.com/public/index.php?task=home), IBM Watson (see, for example, http://www.ibm.com/smarterplanet/us/en/ibmwatson/developercloud/speech-to-text.html), AT&T Speech API (see, for example, http://developer.att.com/apis/speech), or Google Speech API (see, for example, https://www.google.com/intl/en/chrome/demos/speech.html), although these examples are provided merely as illustrations, and, again, it is not intended that claimed subject matter be limited in scope to illustrative examples. Speech recognition is well known and need not be described here in detail. See, for example, “Computer Speech”, by Manfred R. Schroeder, second edition published in 2004; “Speech Processing: A Dynamic and Optimization-Oriented Approach” published in 2003 by Li Deng and Doug O'Shaughnessey; and “Speech and Language Processing (2008)” by Jurafsky and Martin.

Live performances may potentially involve multiple speakers and, therefore, multiple live audio sources. For example, in a theatre performance, multiple actors or actresses may speak and generate live audio component signals. In an embodiment, for example, an audio mixer, a sound board, and/or a similar device having appropriate capabilities, may be employed to process at least two audio signals having audible speech content. In an embodiment, performance speech audio signal components may be formatted in a variety of manners, which may include, for example, substantially in accordance with the AES3-2009 (Revision 2014) standard or specification, available from the Audio Engineering Society, and/or substantially in accordance with any and all previous versions, and/or substantially in accordance with Dante technology, available from Audinate Pty. Ltd., Sydney, Australia.

In an embodiment, a computing device 105 may further comprise a display, and may have a capability of rasterizing or otherwise rendering caption text through further processing. For example, caption text content may be provided in the form of Unicode or a similar standard character representation of text. The most commonly used character encodings are UTF-8 and UTF-16, available from the Unicode Consortium, although any version of Unicode, or another character representation approach may be employed.

Likewise, caption text content may comprise a particular font to be rasterized in an embodiment, although claimed subject matter is not limited in scope in this respect. For example, in an embodiment, alternate fonts, colors and/or other characteristics of text to be displayed may be employed for a variety of possible reasons in an embodiment. As simply one example, on a display, it may be desirable to distinguish audio sources of speech, for example, as suggested above, such as in a live theater production. Rasterization and/or other rendering of text is well-known and need not be described in detail here. See, for example, “A Treatise on Font Rasterisation With an Emphasis on Free Software”. freddie.witherden.org. 2009 Dec. 29.

Likewise, computing device 105 may include one or more frame buffers for use in displaying caption text content. Thus, binary digital signals may be loaded into one or more frame buffers for display to a user. In an embodiment, a display may comprise a smart phone screen, a tablet screen, a laptop screen, etc. In an embodiment, a computing device and display may comprise a single physically integrated device. However, again, these examples are provided merely as illustrations, a variety or embodiments are possible, and it is not intended that claimed subject matter is limited in scope to illustrative examples.

However, as noted previously, an embodiment may include computing devices 105, 110 and 120, for example, which may communicate, such as via a computing and/or communications network, as previously explained. Thus, in an embodiment, computing device 105 may communicate a performance speech audio signal, now in digital form, to another device, such as computing device 110, as shown in FIG. 1. In an embodiment, for example, speech recognition may be performed by a third party at computing device 110 instead of at computing device 105. Thus, a remote computing device, such as a server, may be employed to implement speech recognition. In an embodiment, executable instructions stored in a memory of computing device 110 and executable by a processor of 110 may generate a caption text signal, for example.

In an embodiment, computing device 105, if converting performance speech audio content to caption text content, or computing device 110, if converting performance speech audio content to caption text content, may further generate formatted caption text content by adding and/or appending additional fields and/or values to signals having caption text content. In an embodiment, computing device 105 may add additional formatting and/or characters to caption text content to provide additional features for processing, authenticating, and/or transferring caption text. In an embodiment, for example, if formatting and/or characters are added, computing device 105 may generate enhanced and formatted caption text content. In an embodiment, for example, additional formatting and/or characters may comprise event values, channel values, access key(s), or any combination thereof, which are described in more detail below.

For example, in an embodiment, referring to FIG. 1, computing device 105 may generate performance level speech audio content from live audio content, as was described, for example. Likewise, as a result of communications between computing devices 105 and 110, computing device 110 may generate caption text content from performance level speech content. Similarly, as a result of communications between computing devices 110 and 102, computing device 120 may rasterize or otherwise render enhanced and formatted caption text content for display.

As mentioned previously, computing devices may, as an example, “pull” signals from another device, such as a server, whereas in some embodiments, another device, such as a server, again, as an example, may “push” signals to another computing device. This may take place a variety of ways, which may be periodic, scheduled, or asynchronous, as examples. Communications involving binary digital signals, such as via a computing and/or communications network, for example, has been described in some detail previously, and need not be repeated here, other than in passing reference. Of course, claimed subject matter is not limited in scope to such approaches. Rather, these are provided as illustrative examples.

In an embodiment, an audio mixer may include or add channel value components to performance audio speech signal components, where a channel value may be employed to identify an audio source for a live audio signal. In an embodiment, an audio mixer may communicate a performance audio signal with multiple performance audio speech signal components and associated channel values. For example, in an embodiment, if a performance audio speech signal has three performance audio speech signal components, a computing device 210 may generate a signal having a first caption text content component for a first channel value, a second caption text content component for a second channel value, and/or a third caption text content component for a third channel value.

Furthermore, formatted and enhanced caption text content may result in display of different caption text components according to different display characteristics. In this context, “display characteristics” may refer to different display colors, different text bubble shapes, different font types, different display frequency (e.g., blinking, flashing), different shading, and/or having icons and/or photographs associated be rendered along with generated caption text. For example, a display characteristic corresponding and/or mapped to caption text component A may identify that caption text component A is displayed as a bubble shape in green, wherein a display characteristic corresponding or mapped to caption text component B may be displayed blinking in garnet red. Of course, embodiments are meant to illustrative examples rather than be limiting with respect to claimed subject matter.

In an embodiment, another feature related to formatted and enhanced caption text content may comprise channeling, authentication and appropriate transfer of content, such as caption text content. Of course, such features may likewise be employed in connection with transfer of performance speech audio content. Nonetheless, continuing with an example of caption text content, for example, a channel value component may be included in caption text content to identify a live audio source, for example. Similarly, a computing device, such as 120, may include an event value, indicating an appropriate end point for particular caption text content. Thus, in an embodiment, corresponding channel and event values may be employed so that transfer of appropriate originating content is also displayed appropriately, as desired. Thus, if channel and event values do not correspond, for example, caption text will not be displayed by computing device 120 in an appropriate embodiment.

Alternatively or in addition, authentication and/or encryption may be employed. Authentication and/or encryption are well-known and need not be described in detail here. Two publications from the National Institute of Standards and Technology (NIST), as an example, describe authentication systems: One report describes a NIST-led international standard, ISO/IEC 24727, which defines a general-purpose identity application programming interface (API). Another is a draft publication on refinements to the Personal Identity Verification (PIV) specification. See, “New NIST Publications Describe Standards for Identity Credentials and Authentication Systems,” http://www.nist.gov/itl/csd/piv_090809.cfm. Regarding encryption, see, Bellare, Mihir. “Public-Key Encryption in a Multi-user Setting: Security Proofs and Improvements.” Springer Berlin Heidelberg, 2000. Nonetheless, a variety of authentication and/or encryption techniques may be utilized, which may include use of authentication certificates, two factor authentication, use of symmetric encryption keys, etc. In an embodiment, for example, computing device 110 may authenticate computing device 120 if computing device 120 is within a predetermined range of computing device 110, as one example. In another embodiment, computing device 110 may authenticate computing device 120 if computing device 120 communicates an access key to a computing device 110, in another example. Perhaps, as an illustration, a user of computing device 120 has enrolled at a particular event, for example, in which a live audio source is being converted ultimately to caption text, as has been described in detail above.

In an embodiment, a computing device may also produce audible sound, such as substantially in accordance a performance level audio speech signal. For example, in an embodiment, an individual who may not have a hearing impairment may be utilizing computing device 120 along with an individual who has a hearing impairment. Thus, for example, computing device 120 may produce audible sound via a speaker while also displaying caption text content, as was described. In an embodiment, computing device 120 may likewise translate caption text content to text for a language other than the language of the performance audio speech signal to thereby generate a signal having translated caption text content. Likewise, via speech synthesis, in an embodiment, translated caption text content may be employed to produce audible speech in a language other than the language of the performance audio speech signal and be heard via a speaker, as was mentioned. Of course, embodiments are meant to illustrative examples rather than be limiting with respect to claimed subject matter.

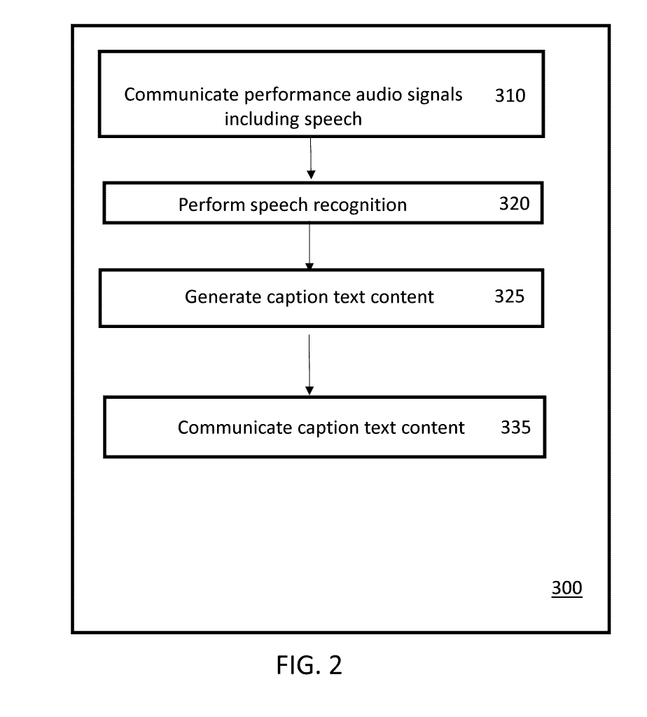

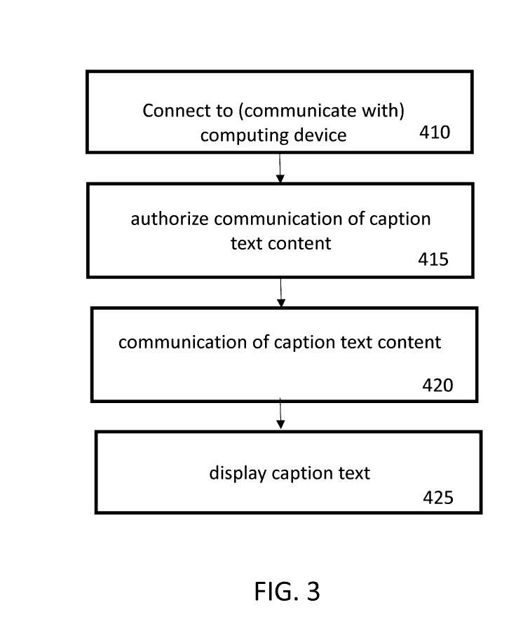

FIGS. 2 and 3 are flow diagrams for an embodiment of a process for use of the embodiment of FIG. 1. However, again, claimed subject matter is not limited to illustrative examples, such as FIG. 1, 2, 3 or 4, for example. Of course, embodiments are meant to illustrative examples rather than be limiting with respect to claimed subject matter. Thus, it is intended that alternate arrangements of components in other implementations be included within claimed subject matter. Likewise, an embodiment of a method may include blocks in addition to those shown and described, fewer blocks, blocks occurring in a different order than may be identified, or combinations thereof. Likewise, for ease of implementation, an embodiment may be simplified to illustrate aspects and/or features in a manner that is intended to not obscure claimed subject matter through excessive specificity and/or unnecessary details. Embodiments in accordance with claimed subject matter may include all of, less than, or more than blocks 310-335 and/or 410-425. Also, the order of blocks 310-335 and/or 410-425 is merely as an example order.

FIG. 2 illustrates a process according to an embodiment 300. In an embodiment, a performance audio speech signal may be generated, such as from a live audio source, as previously described. In particular, a live performance to an audience may produce a live audio signal; however, it may be desirable to reduce ambient noise and/or other sounds other than speech intended to be converted to caption text. At block 310, for example, a performance audio signal including audible speech content, may be generated via processing at a computing device, such as previously described. As described, a combination of various approaches may be employed, including signal processing and other techniques.

At block 320, performance audio signals having audio speech content may be processed, such as by performing speech recognition. A computing device may process a performance audio speech signal, such as by performing speech recognition, which may include converting a performance audio signal into a signal having text content. At block 325, signals having text content may be converted into a signal having caption text content, which may include formatted and enhanced content, as previously described for example. This is only an illustrative embodiment and should not limit the claimed subject matter. At block 335, a computing device may communicate with another device so that signals having caption text content, such as formatted and enhanced text content, are transferred. For example, computing and/or communications network, which may include wireless communications, may be employed, as has been described previously. In an embodiment, a computing device may process signals having caption text content so as to display caption text content.

FIG. 3 is a flow diagram of another process according to an embodiment. Referring to FIG. 3, at block 410, a computing device, such as a user's portable electronic device, e.g., a smart phone, a tablet, or a laptop computer, may communicate with (or connect to) another computing device, for example, so that caption text content may be transferred. In an embodiment, a computing device may connect to (or communicate with) a computing device, for example, via a computing and/or communications network, as previously mentioned. At block 415, transfer of signals having caption text content may be authorized and/or authenticated by any one of a host of approaches, such as using an access key, an event value, or combination thereof, as previously described. In an embodiment, transfer may be authorized if a computing device is located within a predetermined distance or range of another computing device, for example. In an embodiment, transfer may be authorized if a computing device is located within a predetermined distance of a specified location.

At block 420, in an embodiment, signals having caption text content may be communicated. As previously described, in one embodiment, signals may be “pulled.” For example, one computing device may poll another computing device and/or read signals out of memory of another computing device. In another embodiment, signals may be “pushed”. For example, signals may be transmitted from one computing device to another.

In an embodiment, a computing device may process signals having caption text content so as to be displayed, illustrated, for example, by block 425. In an embodiment, a monitor and/or display may comprise a tablet display, a computer screen, etc. For example, in one embodiment, caption text to be displayed may be loaded into a frame buffer.

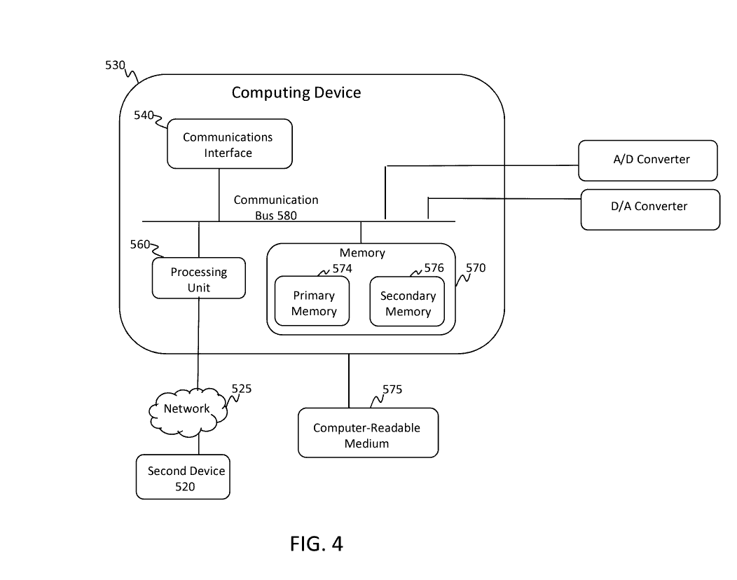

For purposes of illustration, FIG. 4 is an illustration of an embodiment 500 of a system that may be employed in a client-server type interaction, such as described infra, in connection with rendering a GUI via a device, for example, such as a smart phone or similar mobile device, which may, for example, include a computing device 530. Thus, computing device 530 may include a capability to execute instructions, such as may be stored in a memory, such as 570. For example, an audio source may communicate performance audio signals having audible speech content to a device, such as 530. In order to increase a viability of real-time captioning of live performances, instructions may be stored locally and executable to process performance audio signals, such as to convert performance audio signals, via speech recognition, to a signal having caption text components. In addition, instructions may be stored locally and further executable to generate and transmit analog or digital signals having caption text components to a computing device for rendering on a monitor. Alternately, electronic signal transmissions may be initiated across a network, such as 525, to a second device, such as 520, which may comprise a server. Thus, server 420, for example, may include stored executable instructions to process performance audio signals having audible speech content utilizing speech recognition and to generate analog or digital signals having caption text components, where analog or digital signals having caption text components may be communicated back to device 530, for example. It is, of course, noted that device 520 may comprise more than one server as well. Stored instructions may be executable, such as by computing device 530, as previously suggested, to perform various types of signal processing. It is likewise noted that in a smart phone embodiment, for example, computing device 530 may provide digital signals to a D/A converter and/or may receive digital signals from an A/D converter, as shown. In addition, computing device 530 may include a communications interface 540, a processor (e.g., processing unit) 560, a memory 570, which may comprise primary memory 574 and secondary memory 576, and may communicate by way of a communication bus 580, for example.

In an embodiment, the computing device 530 may be coupled or connected to a computer-readable medium 575. In FIG. 4, the computing device may represent one or more sources of analog, uncompressed digital, lossless compressed digital, and/or lossy compressed digital formats for content of various types, such as video, imaging, text, audio, etc. in the form physical states and/or signals, for example. Computing device 530 may communicate with other computing devices by way of a connection, such as an internet connection, via network 525, for example. Although the computing device of FIG. 4 shows the above-identified components, claimed subject matter is not limited to computing devices having only these components as other implementations may include alternative arrangements that may comprise additional components or fewer components, such as components that function differently while achieving similar results. Rather, examples are provided merely as illustrations. It is not intended that claimed subject matter to limited in scope to illustrative examples.

Nonetheless, continuing, processor (processing unit) 560 may be representative of one or more circuits, such as digital circuits, to perform at least a portion of a computing procedure and/or process. By way of example, but not limitation, processor 560 may comprise one or more processors, such as controllers, microprocessors, microcontrollers, application specific integrated circuits, digital signal processors, programmable logic devices, field programmable gate arrays, the like, or any combination thereof. In implementations, processor 560 may perform signal processing to manipulate signals and/or states, to construct signals and/or states, etc., for example, as was mentioned.

Under direction of processor 560, memory 570, such as memory cells storing physical states, representing, for example, a program, may be executed by processor 560 and generated signals may be transmitted via the Internet, for example. Processor 560 may also receive digitally-encoded signals from another computing device, such as 520.

Memory 570 may be representative of any storage mechanism. Memory 570 may comprise, for example, primary memory 574 and secondary memory 576, additional memory circuits, mechanisms, or combinations thereof may be used. Memory 570 may comprise, for example, random access memory, read only memory, etc., such as in the form of one or more storage devices and/or systems, such as, for example, a disk drive, an optical disc drive, a tape drive, a solid-state memory drive, etc., just to name a few examples. Memory 570 may be utilized to store a program. Memory 570 may also comprise a memory controller for accessing computer readable-medium 575 that may carry and/or make accessible content, which may include code, and/or instructions, for example, executable by processor 560 and/or some other unit, such as a controller and/or processor, capable of executing instructions, for example.

Network 525 may comprise one or more network communication links, processes, services, applications and/or resources to support exchanging communication signals between a client computing device, such as 530, and second computing device 520 (‘second device’ in figure), which may, for example, comprise one or more servers (not shown). By way of example, but not limitation, network 525 may comprise wireless and/or wired communication links, telephone and/or telecommunications systems, Wi-Fi networks, Wi-MAX networks, the Internet, a local area network (LAN), a wide area network (WAN), or any combinations thereof.

The term “computing device,” as used herein, refers to a system and/or a device, such as a computing apparatus, that includes a capability to process (e.g., perform computations) and/or store content, such as measurements, text, images, video, audio, etc. in the form of signals and/or states. Thus, a computing device, in this context, may comprise hardware, software, firmware, or any combination thereof (other than software per se). Computing device 530, as depicted in FIG. 4, is merely one example, and claimed subject matter is not limited in scope to this particular example. For one or more embodiments, a computing device may comprise any of a wide range of digital electronic devices, including, but not limited to, personal desktop and/or notebook computers, high-definition televisions, digital versatile disc (DVD) players and/or recorders, game consoles, satellite television receivers, cellular telephones, wearable devices, personal digital assistants, mobile audio and/or video playback and/or recording devices, or any combination of the above. Further, unless specifically stated otherwise, a process as described herein, with reference to flow diagrams and/or otherwise, may also be executed and/or affected, in whole or in part, by a computing platform

Memory 570 may store cookies relating to one or more users and may also comprise a computer-readable medium that may carry and/or make accessible content, including code and/or instructions, for example, executable by processor 560 and/or some other unit, such as a controller and/or processor, capable of executing instructions, for example. A user may make use of an input device, such as a computer mouse, stylus, track ball, keyboard, and/or any other similar device capable of receiving user actions and/or motions as input signals. Likewise, a user may make use of an output device, such as a display, a printer, etc., and/or any other device capable of providing signals and/or generating stimuli for a user, such as visual stimuli, audio stimuli and/or other similar stimuli.

Regarding aspects related to a communications and/or computing network, a wireless network may couple client devices with a network. A wireless network may employ stand-alone ad-hoc networks, mesh networks, Wireless LAN (WLAN) networks, cellular networks, and/or the like. A wireless network may further include a system of terminals, gateways, routers, and/or the like coupled by wireless radio links, and/or the like, which may move freely, randomly and/or organize themselves arbitrarily, such that network topology may change, at times even rapidly. A wireless network may further employ a plurality of network access technologies, including Long Term Evolution (LTE), WLAN, Wireless Router (WR) mesh, 2nd, 3rd, or 4th generation (2G, 3G, or 4G) cellular technology and/or the like. Network access technologies may enable wide area coverage for devices, such as client devices with varying degrees of mobility, for example.

A network may enable radio frequency and/or other wireless type communications via a wireless network access technology and/or air interface, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, ultra wideband (UWB), 802.11b/g/n, and/or the like. A wireless network may include virtually any type of now known and/or to be developed wireless communication mechanism by which signals may be communicated between devices, between networks, within a network, and/or the like.

Communications between a computing device and/or a network device and a wireless network may be in accordance with known and/or to be developed communication network protocols including, for example, global system for mobile communications (GSM), enhanced data rate for GSM evolution (EDGE), 802.11b/g/n, and/or worldwide interoperability for microwave access (WiMAX). A computing device and/or a networking device may also have a subscriber identity module (SIM) card, which, for example, may comprise a detachable or embedded smart card that is able to store subscription content of a user, and/or is also able to store a contact list of the user. A user may own the computing device and/or networking device or may otherwise be a user, such as a primary user, for example. A computing device may be assigned an address by a wireless network operator, a wired network operator, and/or an Internet Service Provider (ISP). For example, an address may comprise a domestic or international telephone number, an Internet Protocol (IP) address, and/or one or more other identifiers. In other embodiments, a computing and/or communications network may be embodied as a wired network, wireless network, or any combinations thereof.

A device, such as a computing and/or networking device, may vary in terms of capabilities and/or features. Claimed subject matter is intended to cover a wide range of potential variations. For example, a device may include a numeric keypad and/or other display of limited functionality, such as a monochrome liquid crystal display (LCD) for displaying text, for example. In contrast, however, as another example, a web-enabled device may include a physical and/or a virtual keyboard, mass storage, one or more accelerometers, one or more gyroscopes, global positioning system (GPS) and/or other location-identifying type capability, and/or a display with a higher degree of functionality, such as a touch-sensitive color 2D or 3D display, for example.

A computing and/or network device may include and/or may execute a variety of now known and/or to be developed operating systems, derivatives and/or versions thereof, including personal computer operating systems, such as a Windows, iOS, Linux, a mobile operating system, such as iOS, Android, Windows Mobile, and/or the like. A computing device and/or network device may include and/or may execute a variety of possible applications, such as a client software application enabling communication with other devices, such as communicating one or more messages, such as via protocols suitable for transmission of email, short message service (SMS), and/or multimedia message service (MMS), including via a network, such as a social network including, but not limited to, Facebook, LinkedIn, Twitter, Flickr, and/or Google+, to provide only a few examples. A computing and/or network device may also include and/or execute a software application to communicate content, such as, for example, textual content, multimedia content, and/or the like. A computing and/or network device may also include and/or execute a software application to perform a variety of possible tasks, such as browsing, searching, playing various forms of content, including locally stored and/or streamed video, and/or games such as, but not limited to, fantasy sports leagues. The foregoing is provided merely to illustrate that claimed subject matter is intended to include a wide range of possible features and/or capabilities.

A network may also be extended to another device communicating as part of another network, such as via a virtual private network (VPN). To support a VPN, broadcast domain signal transmissions may be forwarded to the VPN device via another network. For example, a software tunnel may be created between a logical broadcast domain, and a VPN device. Tunneled traffic may, or may not be encrypted, and a tunneling protocol may be substantially compliant with and/or substantially compatible with any now known and/or to be developed versions of any of the following protocols: IPSec, Transport Layer Security, Datagram Transport Layer Security, Microsoft Point-to-Point Encryption, Microsoft's Secure Socket Tunneling Protocol, Multipath Virtual Private Network, Secure Shell VPN, another existing protocol, and/or another protocol that may be developed.

A network may communicate via signal packets and/or frames, such as in a network of participating digital communications. A broadcast domain may be substantially compliant and/or substantially compatible with, but is not limited to, now known and/or to be developed versions of any of the following network protocol stacks: ARCNET, AppleTalk, ATM, Bluetooth, DECnet, Ethernet, FDDI, Frame Relay, HIPPI, IEEE 1394, IEEE 802.11, IEEE-488, Internet Protocol Suite, IPX, Myrinet, OSI Protocol Suite, QsNet, RS-232, SPX, System Network Architecture, Token Ring, USB, and/or X.25. A broadcast domain may employ, for example, TCP/IP, UDP, DECnet, NetBEUI, IPX, Appletalk, other, and/or the like. Versions of the Internet Protocol (IP) may include IPv4, IPv6, other, and/or the like.

Algorithmic descriptions and/or symbolic representations are examples of techniques used by those of ordinary skill in the signal processing and/or related arts to convey the substance of their work to others skilled in the art. An algorithm is here, and generally, is considered to be a self-consistent sequence of operations and/or similar signal processing leading to a desired result. In this context, operations and/or processing involves physical manipulation of physical quantities. Typically, although not necessarily, such quantities may take the form of electrical and/or magnetic signals and/or states capable of being stored, transferred, combined, compared, processed or otherwise manipulated as electronic signals and/or states representing various forms of content, such as signal measurements, text, images, video, audio, etc. It has proven convenient at times, principally for reasons of common usage, to refer to such physical signals and/or physical states as bits, values, elements, symbols, characters, terms, numbers, numerals, measurements, content and/or the like. It should be understood, however, that all of these and/or similar terms are to be associated with appropriate physical quantities and are merely convenient labels. Unless specifically stated otherwise, as apparent from the preceding discussion, it is appreciated that throughout this specification discussions utilizing terms such as “processing,” “computing,” “calculating,” “determining”, “establishing”, “obtaining”, “identifying”, “selecting”, “generating”, and/or the like may refer to actions and/or processes of a specific apparatus, such as a special purpose computer and/or a similar special purpose computing and/or network device. In the context of this specification, therefore, a special purpose computer and/or a similar special purpose computing and/or network device is capable of processing, manipulating and/or transforming signals and/or states, typically represented as physical electronic and/or magnetic quantities within memories, registers, and/or other storage devices, transmission devices, and/or display devices of the special purpose computer and/or similar special purpose computing and/or network device. In the context of this particular patent application, as mentioned, the term “specific apparatus” may include a general purpose computing and/or network device, such as a general purpose computer, once it is programmed to perform particular functions pursuant to instructions from program software.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and/or storage of charge or a release of stored charge. Likewise, in other memory devices, a change of state may comprise a physical change, such as a transformation in magnetic orientation and/or a physical change and/or transformation in molecular structure, such as from crystalline to amorphous or vice-versa. In still other memory devices, a change in physical state may involve quantum mechanical phenomena, such as, superposition, entanglement, and/or the like, which may involve quantum bits (qubits), for example. The foregoing is not intended to be an exhaustive list of all examples in which a change in state form a binary one to a binary zero or vice-versa in a memory device may comprise a transformation, such as a physical transformation. Rather, the foregoing is intended as illustrative examples.

In the preceding description, various aspects of claimed subject matter have been described. For purposes of explanation, specifics, such as amounts, systems and/or configurations, as examples, were set forth. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all modifications and/or changes as fall within claimed subject matter.

1. A method comprising:
converting, via a computing device, a performance audio speech signal to a caption text signal; and
communicating the caption text signal so as to display the caption text content of the caption text signal.

2. The method of claim 1, wherein before the converting the performance audio speech signal to a caption text signal, converting the form of the performance audio speech signal between an analog form and a digital form.

3. The method of claim 1, wherein the performance audio speech signal comprises a plurality of signal components, the plurality of signal components comprising a channel value signal component identifying a live audio source for one or more other signal components of the performance audio speech signal.

4. The method of claim 3, wherein the communicating the caption text signal comprises communicating the caption text signal to another computing device based at least in part on the channel value and an event value for the another computing device.

5. The method of claim 1, wherein the communicating the caption text signal comprises communicating the caption text signal to another computing device based at least in part on authentication provided by the another computing device.

6. The method of claim 1, and further comprising: translating the caption text signal to caption text for a language other than the language of the performance audio speech signal.

7. The method of claim 6, and further comprising: generating a translated audio speech signal from the caption text for a language other than the language of the performance audio speech signal; and
communicating the translated audio speech signal to another computing device for playback by the another computing device.

8. The method of claim 1, wherein the computing device comprises a server; and wherein the communicating the caption text signal so as to display the caption text content of the caption text signal comprises: communicating the caption text signal from the server to another computing device and processing the caption text for display by the another computing device.

9. The method of claim 1, wherein the communicating the caption text signal so as to display the caption text content of the caption text signal comprises: loading the caption text signal to a frame buffer of the computing device so as to display the caption text content of the caption text signal.

10. An apparatus comprising: a computing device; the computing device to convert a performance audio speech signal to a caption text signal;
the performance audio speech signal to originate from a live audio source.

11. The apparatus of claim 10, wherein the computing device comprises one or more processors coupled to a memory via a communication bus.

12. The apparatus of claim 10, wherein the computing device includes an audio input port for communication of the performance audio speech signal.

13. An article comprising: a storage medium having stored thereon instructions executable by a computing device to convert a performance audio speech signal to a caption text signal; wherein the performance audio speech signal is to originate at a live audio source.

14. The article of claim 13, wherein the executable instructions further to process caption text content of the caption text signal for display.

15. The article of claim 13, wherein the executable instructions further to display on a display of the computing device the caption text content.

16. An apparatus comprising: a computing device; wherein the computing device comprises means to convert a performance audio speech signal to a caption text signal; the performance audio speech signal to originate from a live audio source.

17. The apparatus of claim 16, wherein the computing device comprises means for communicating between a processor and a memory of the computing device

18. The apparatus of claim 16, wherein the computing device includes means for communication of the performance audio speech signal to the computing device.
